(19) United States
(12) Patent Application Publication
(10) Pub. No.: US 2002/0099745 A1
(43) Pub. Date: Jul. 25, 2002

(54) Method and system for storing a flattened structured data document

(75) Inventors: Kevin Lawrence Huck, Woodland Park, CO (US); Christopher Lockton Brandin, Colorado Springs, CO (US); Linda Lee Grimaldi, Colorado Springs, CO (US)

Correspondence Address: Law Office of Dale B. Halling, LLC, Suite 311, 24 S. Weber Street, Colorado Springs, CO, 80903, US

(73) Assignee: Neo-Core, L.L.C.

(21) Appl. No.: 09/767,797

(22) Filed: Jan. 23, 2001

(51) Int. Cl. G06F 15/00

(52) U.S. Cl. 707/532; 707/513

(57) ABSTRACT

A method of storing a flattened structured data document, includes the steps of receiving the flattened structured data document. The flattened structured data document has a number of lines, each of the lines has a tag, a data entry and a format character. The tag is stored in a dictionary store. The data entry is stored in a dictionary store. The format character, a tag dictionary offset and a data dictionary offset are stored in a map store.

### RELATED APPLICATIONS

This patent application is related to the U.S. patent application, Ser. No. 09/419,217, entitled “Memory Management System and Method” filed on Oct. 15, 1999, assigned to the same assignee as the present application and the U.S. patent application, Serial No. ?? (NEO-0002), entitled “Method of Storing a Structured Data Document” filed on Jan. 23, 2001, assigned to the same assignee as the present application and the U.S. patent application, Ser. No. ?? (NEO-0004), entitled “Method Of Performing A Search Of A Numerical Document Object Model” filed on Jan. 23, 2001, assigned to the same assignee as the present application Ser. No. ?? and the U.S. patent application, (NEO-0005), entitled “Method of Operating an Extensible Markup Language Database” filed on Jan. 23, 2001, assigned to the same assignee as the present application.

### FIELD OF THE INVENTION

The present invention relates generally to the field of structured data documents and more particularly to a method and system for storing a flattened structured data document.

### BACKGROUND OF THE INVENTION

Structured data documents such as HTML (Hyper Text Markup Language), XML (extensible Markup Language) and SGML (Standard Generalized Markup Language) documents and derivatives use tags to describe the data associated with the tags. This has an advantage over databases in that not all the fields are required to be predefined. XML is presently finding widespread interest for exchanging information between businesses. XML appears to provide an excellent solution for internet business to business applications. Unfortunately, XML documents require a lot of memory and bandwidth to transmit efficiently.

Thus there exists a need for a method and system for storing a flattened structured data document that reduces the memory and bandwidth requirements associated with using these documents.

### BRIEF DESCRIPTION OF THE DRAWINGS

FIG. 1 is an example of an XML document in accordance with one embodiment of the invention;

FIG. 2 is an example of a flattened data document in accordance with one embodiment of the invention;

FIG. 3 is a block diagram of a system for storing a flattened data document in accordance with one embodiment of the invention;

FIG. 4 shows two examples of a map store cell in accordance with one embodiment of the invention;

FIG. 5 is a flow chart of a method of storing a structured data document in accordance with one embodiment of the invention;

FIG. 6 is a flow chart of a method of storing a structured data document in accordance with one embodiment of the invention;

FIG. 7 is a flow chart of a method of storing a structured data document in accordance with one embodiment of the invention;

FIG. 8 is a block diagram of a system for storing a flattened structured data document in accordance with one embodiment of the invention;

FIG. 9 is a block diagram of a system for storing a flattened structured data document in accordance with one embodiment of the invention;

FIG. 10 is a flow chart of the steps used in a method of storing a flattened structured data document in accordance with one embodiment of the invention; and

FIG. 11 is a flow chart of the steps used in a method of storing a flattened structured data document in accordance with one embodiment of the invention.

### DETAILED DESCRIPTION OF THE DRAWINGS

A method of storing a flattened structured data document, includes the steps of receiving the flattened structured data document. The flattened structured data document has a number of lines, each of the lines has a tag, a data entry and a format character. The tag is stored in a dictionary store. The data entry is stored in a dictionary store. The format character, a tag dictionary offset and a data dictionary offset are stored in a map store. In one embodiment, an associative index (dictionary index) is created to easily determine if a data entry or tag has been stored in the dictionary store. This method significantly reduces the size of a structured data document and the ease of storing the document.

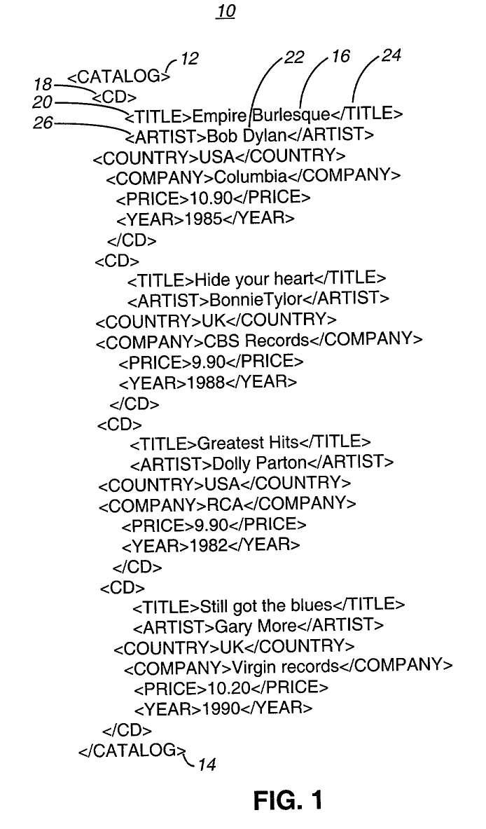

FIG. 1 is an example of an XML document 10 in accordance with one embodiment of the invention. The words between the <> are tags that describe the data. This document is a catalog 12. Note that all tags are opened and later closed. For instance <catalog> 12 is closed at the end of the document </catalog> 14. The first data item is “Empire Burlesque” 16. The tags <CD> 18 and <TITLE> 20 tell us that this is the title of the CD (Compact Disk). The next data entry is “Bob Dylan” 22, who is the artist. Other compact disks are described in the document.

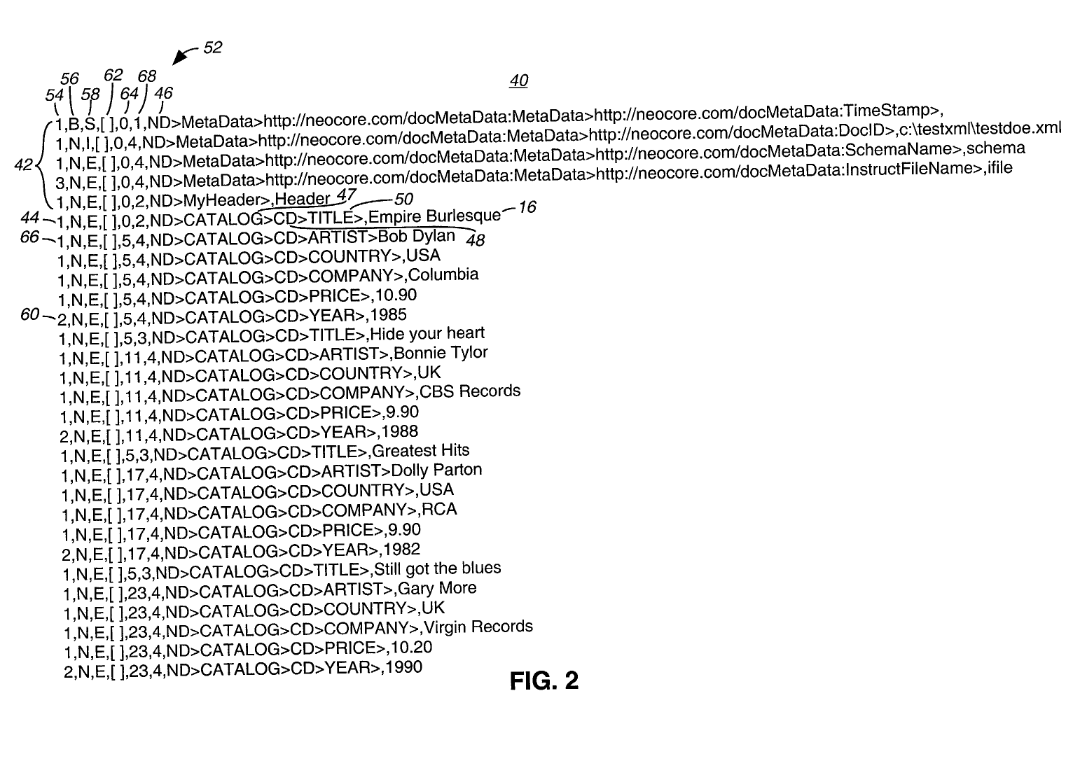

FIG. 2 is an example of a flattened data document 40 in accordance with one embodiment of the invention. The first five lines 42 are used to store parameters about the document. The next line 44 shows a line that has flattened all the tags relating to the first data entry 16 of the XML document 10. Note that the tag <ND> 46 is added before every line but is not required by the invention. The next tag is CATALOG> 47 which is the same as in the XML document 10. Then the tag CD> 48 is shown and finally the tag TITLE> 50. Note this is the same order as the tags in the XML document 10. A plurality of formatting characters 52 are shown to the right of each line. The first column is the n-tag level 54. The n-tag defines the number of tags that closed in that line. Note that first line 44, which ends with the data entry “Empire Burlesque” 16, has a tag 24 (FIG. 1) that closes the tag TITLE. The next tag 26 opens the tag ARTIST. As a result the n-tag for line 44 is a one. Note that line 60 has an n-tag of two. This line corresponds to the data entry 1985 and both the YEAR and the CD tags are closed.

The next column 56 has a format character that defines whether the line is first (F) or another line follows it (N-next) or the line is the last (L). The next column contains a line type definition 58. Some of the line types are: time stamp (S); normal (E); identification (I); attribute (A); and processing (P). The next column 62 is a delete level and is enclosed in a parenthesis. When a delete command is received the data is not actually erased but is eliminated by entering a number in the parameters in a line to be erased. So for instance if a delete command is received for “Empire Burlesque” 16, a “1” would be entered into the parenthesis of line 44. If a delete command was received for “Empire Burlesque” 16 and <TITLE>, </TITLE>, a “2” would be entered into the parenthesis. The next column is the parent line 64 of the current line. Thus the parent line for the line 66 is the first line containing the tag CATALOG. If you count the lines you will see that this is line five (5) or the preceding line. The last column of formatting characters is a p-level 68. The p-level 68 is the first new tag opened but not closed. Thus at line 44, which corresponds to the data entry “Empire Burlesque” 16, the first new tag opened is CATALOG. In addition the tag CATALOG is not closed. Thus the p-level is two (2).

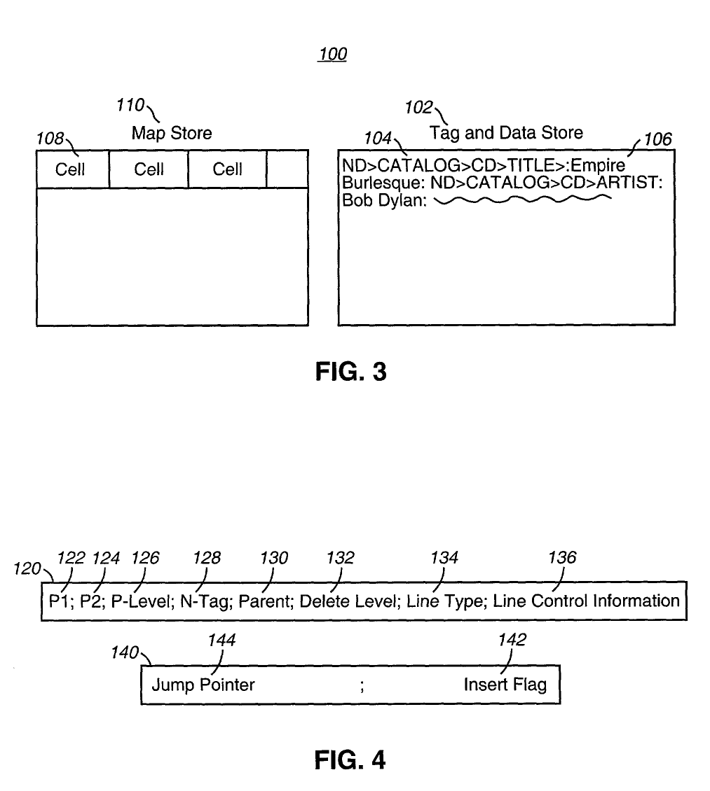

FIG. 3 is a block diagram of a system 100 for storing a flattened data document in accordance with one embodiment of the invention. Once the structured data document is flattened as shown in FIG. 2, it can be stored. Each unique tag or unique set of tags for each line is stored to a tag and data store 102. The first entry in the tag and data store is ND>CATALOG>CD>TITLE> 104. Next the data entry “Empire Burlesque” 106 is stored in the tag and data store 102. The pointers to the tag and data entry in the tag and data store 102 are substituted into line 44. Updated line 44 is then stored in a first cell 108 of the map store 110. In one embodiment the tag store and the data store are separate. The tag and data store 102 acts as a dictionary, which reduces the required memory size to store the structured data document. Note that the formatting characters allow the structured data document to be completely reconstructed.

FIG. 4 shows two examples of a map store cell in accordance with one embodiment of the invention. The first example 120 works as described above. The cell 120 has a first pointer (P₁) 122 that points to the tag in the tag and data store 102 and a second pointer (P₂) 124 that points to the data entry. The other information is the same as in a flattened line such as: p-level 126; n-tag 128; parent 130; delete level 132; line type 134; and line control information 136. The second cell type 140 is for an insert. When an insert command is received a cell has to moved. The moved cell is replaced with the insert cell 140. The insert cell has an insert flag 142 and a jump pointer 144. The moved cell and the inserted cell are at the jump pointer.

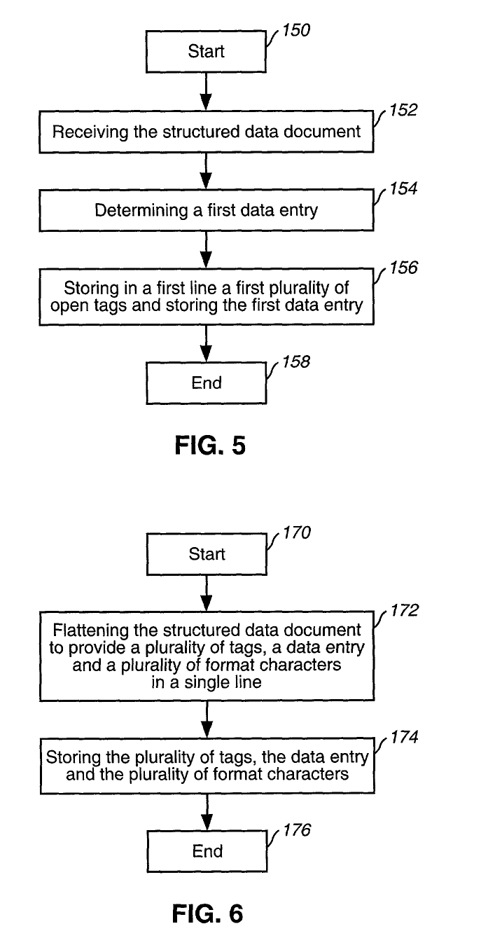

FIG. 5 is a flow chart of a method of storing a structured data document. The process starts, step 150, by receiving the structured data document at step 152. A first data entry is determined at step 154. In one embodiment, the first data entry is an empty data slot. At step 156 a first plurality of open tags and the first data entry is stored which ends the process at step 158. In one embodiment a level of a first opened tag is determined. The level of the first opened tag is stored. In another embodiment, a number of consecutive tags closed after the first data entry is determined. This number is then stored. A line number is stored.

In one embodiment, a next data entry is determined. A next plurality of open tags proceeding the next data entry is stored. These steps are repeated until a next data entry is not found. Note that the first data entry may be a null. A plurality of format characters associated with the next data entry are also stored. In one embodiment the flattened data document is expanded into the structured data document using the plurality of formatting characters.

FIG. 6 is a flow chart of a method of storing a structured data document. The process starts, step 170, by flattening the structured data document to a provide a plurality of tags, a data entry and a plurality of format characters in a single line at step 172. At step 174 the plurality of tags, the data entry and the plurality of format characters are stored which ends the process at step 176. In one embodiment, the plurality of tags are stored in a tag and data store. In addition, the plurality of format characters are stored in map store. The data entry is stored in the tag and data store. A first pointer in the map store points to the plurality of tags in the tag and data store. A second pointer is stored in the map store that points to the data store. In one embodiment, the structured data document is received. A first data entry is determined. A first plurality of open tags proceeding the first data entry and the first data entry are placed in a first line. A next data entry is determined. A next plurality of open tags proceeding the next data entry is placed in the next line. These steps are repeated until a next data entry is not found. In one embodiment a format character is placed in the first line. In one embodiment the format character is a number that indicates a level of a first tag that was opened. In one embodiment the format character is a number that indicates a number of tags that are consecutively closed after the first data entry. In one embodiment the format character is a number that indicates a line number of a parent of a lowest level tag. In one embodiment the format character is a number that indicates a level of a first tag that was opened but not closed. In one embodiment the format character is a character that indicates a line type. In one embodiment the format character indicates a line control information. In one embodiment the structured data document is an extensible markup language document. In one embodiment the next data entry is placed in the next line.

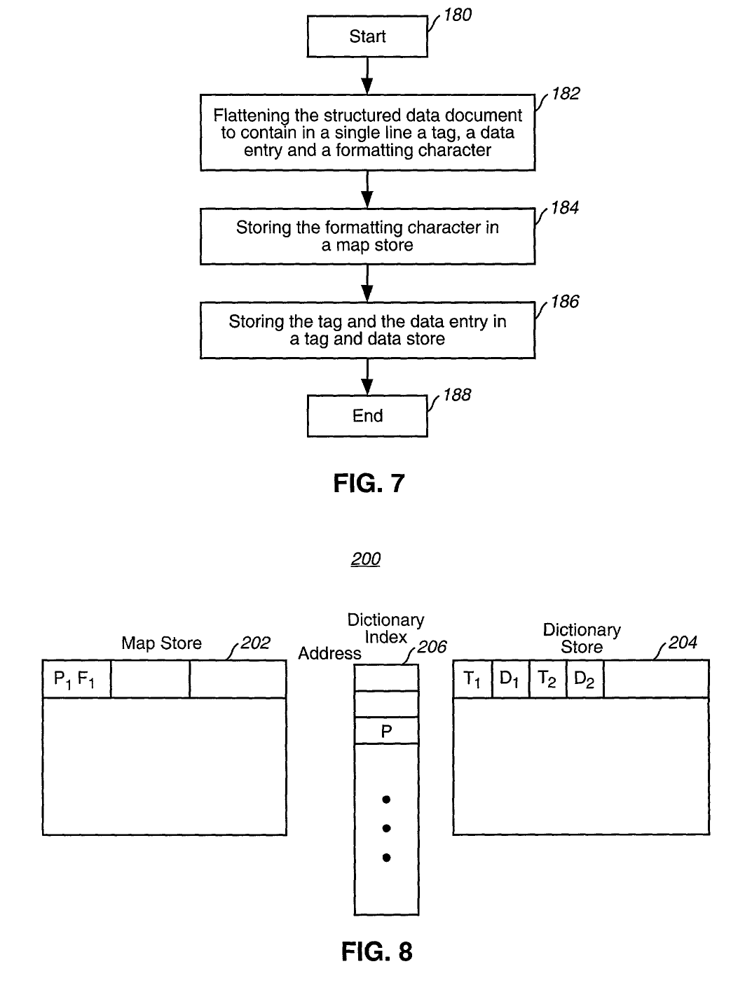

FIG. 7 is a flow chart of a method of storing a structured data document. The process starts, step 180, by flattening the structured data document to contain in a single line a tag, a data entry and a formatting character at step 182. The formatting character is stored in a map store at step 184. At step 186 the tag and the data entry are stored in a tag and data store which ends the process at step 188. In one embodiment a first pointer is stored in the map store that points to the tag in the tag and data store. A second pointer is stored in the map store that points to the data entry in the tag and data store. In one embodiment a cell is created in the map store for each of the plurality of lines in a flattened document. A request is received to delete one of the plurality of data entries. The cell associated with the one of the plurality of data entries is determined. A delete flag is set. Later a restore command is received. The delete flag is unset. In one embodiment, a request to delete one of a plurality of data entries and a plurality of related tags is received. A delete flag is set equal to the number of the plurality of related tags plus one. In one embodiment, a request is received to insert a new entry. A previous cell containing a proceeding data entry is found. The new entry is stored at an end of the map store. A contents of the next cell is moved after the new entry. An insert flag and a pointer to the new entry is stored in the next cell. A second insert flag and second pointer is stored after the contents of the next cell.

Thus there has been described a method of flattening a structured data document. The process of flattening the structured data document generally reduces the number lines used to describe the document. The flattened document is then stored using a dictionary to reduce the memory required to store repeats of tags and data. In addition, the dictionary (tag and data store) allows each cell in the map store to be a fixed length. The result is a compressed document that requires less memory to store and less bandwidth to transmit.

FIG. 8 is a block diagram of a system 200 for storing a flattened structured data document in accordance with one embodiment of the invention. The system 200 has a map store 202, a dictionary store 204 and a dictionary index 206. Note that this structure is similar to the system of FIG. 3. The dictionary store 204 has essentially the same function as the map and tag store (FIG. 3) 102. The difference is that a dictionary index 206 has been added. The dictionary index 206 is an associative index. An associative index transforms the item to be stored, such as a tag, tags or data entry, into an address. Note that in one embodiment the transform returns an address and a confirmer as explained in the U.S. patent application, Ser. No. 09/419,217, entitled “Memory Management System and Method” filed on Oct. 15, 1999, assigned to the same assignee as the present application and hereby incorporated by reference. The advantage of the dictionary index 206 is that when a tag or data entry is received for storage it can be easily determined if the tag or data entry is already stored in the dictionary store 204. If the tag or data entry is already in the dictionary store the offset in the dictionary can be immediately determined and returned for use as a pointer in the map store 202.

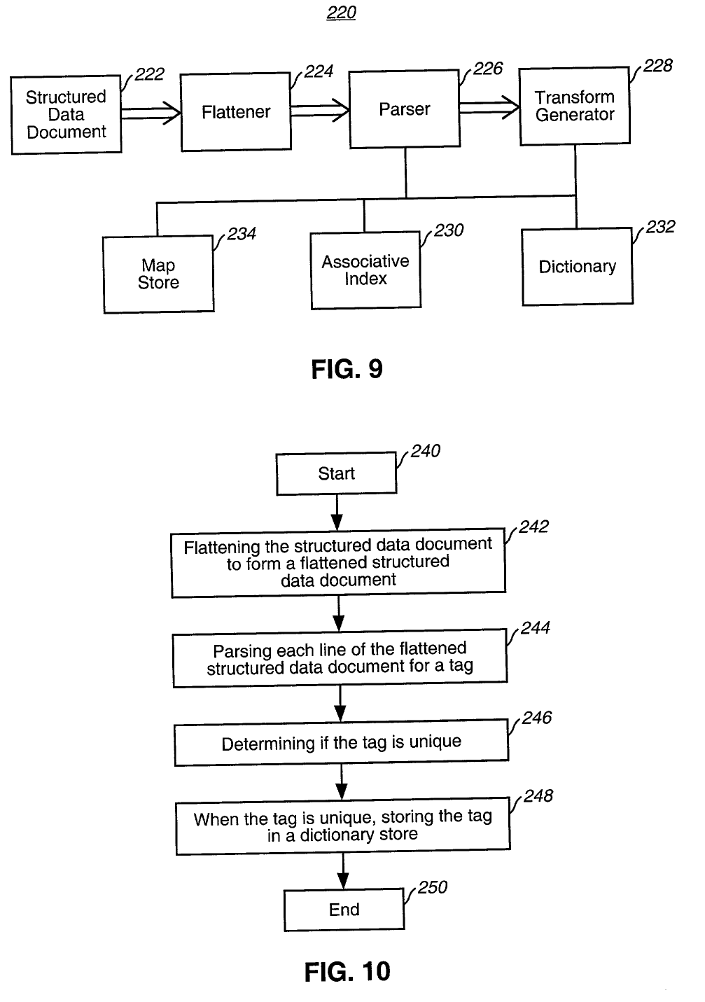

FIG. 9 is a block diagram of a system 220 for storing a flattened structured data document in accordance with one embodiment of the invention. A structured data document 222 is first processed by a flattener 224. The flattener 224 performs the functions described with respect to FIGS. 1 & 2. A parser 226 then determines the data entries and the associated tags. One of the data entries is transformed by the transform generator 228. This is used to determine if the data entry is in the associative index 230. When the data entry is not in the associative index 230, it is stored in the dictionary 232. A pointer to the data in the dictionary is stored at the appropriate address in the associative index 230. The pointer is also stored in a cell of the map store 234 as part of a flattened line.

FIG. 10 is a flow chart of the steps used in a method of storing a flattened structured data document in accordance with one embodiment of the invention. The process starts, step 240, by flattening the structured data document to form a flattened structured data document at step 242. Each line of the flattened structured data document is parsed for a tag at step 244. Next it is determined if the tag is unique at step 246. When the tag is unique, step 248, the tag is stored in a dictionary store which ends the process at step 250. In one embodiment a tag dictionary offset is stored in the map store. A plurality of format characters are stored in the map store. When a tag is not unique, a tag dictionary offset is determined. The tag dictionary offset is stored in the map store.

In one embodiment, the tag is transformed to form a tag transform. An associative lookup is performed in a dictionary index using the tag transform. A map index is created that has a map pointer that points to a location in the map store of the tag. The map pointer is stored at an address of the map index that is associated with the tag transform.

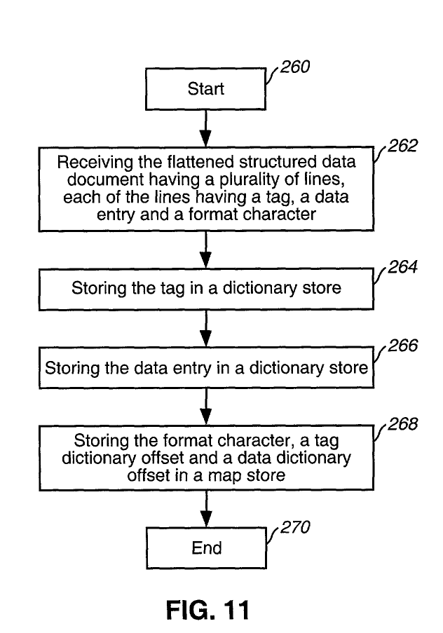

FIG. 11 is a flow chart of the steps used in a method of storing a flattened structured data document in accordance with one embodiment of the invention. The process starts, step 260, by receiving the flattened structured data document that has a plurality of lines at step 262. Each of the plurality of lines contains a tag, a data entry and a format character. The tag is stored in a dictionary store at step 264. The data entry is stored in the dictionary store at step 266. At step 268 the format character, a tag dictionary offset and a data dictionary offset are stored in a map store which ends the process at step 270. In one embodiment, the tag is transformed to form a tag transform. The tag dictionary offset is stored in a dictionary index at an address pointed to by the tag transform. In one embodiment, it is determined if the tag is unique. When the tag is unique, the tag is stored in the dictionary store otherwise the tag is not stored (again) in the dictionary store. To determine if the tag is unique, it is determined if a tag pointer is stored in the dictionary index at an address pointed to by the tag transform.

In one embodiment, the data entry is transformed to form a data transform. The data dictionary offset is stored in the dictionary index at an address pointed to by the data transform. In one embodiment each of the flattened lines has a plurality of tags.

In one embodiment, a map index is created. Next it is determined if the tag is unique. When the tag is unique, a pointer to a map location of the tag is stored in the map index. When the tag is not unique, it is determined if a duplicates flag is set. When the duplicates flag is set, a duplicates count is incremented. When the duplicates flag is not set, the duplicates flag is set. The duplicates count is set to two. In one embodiment a transform of the tag with an instance count is calculated to form a first instance tag transform and a second instance tag transform. A first map pointer is stored in the map index at an address associated with the first instance transform. A second map pointer is stored in the map index at an address associated with the second instance transform.

In one embodiment a transform of the tag with an instances count equal to the duplicates count is calculated to form a next instance tag transform. A next map pointer is stored in the map index at an address associated with the next instance transform.

In one embodiment, a map index is created. Next it is determined if the data entry is unique. When the data entry is unique, a pointer to a map location of the tag is stored.

Thus there has been described an efficient manner of storing a structured data document that requires significantly less memory than conventional techniques. The associative indexes significantly reduces the overhead required by the dictionary.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A method of storing a flattened structured data document, comprising the steps of:
a) receiving the flattened structured data document having a plurality of lines, each of the lines having a tag, a data entry and a format character;
b) storing the tag in a dictionary store;
c) storing the data entry in a dictionary store; and
d) storing the format character, a tag dictionary offset and a data dictionary offset in a map store.

2. The method of claim 1, wherein step (b) further includes the steps of:
b1) transforming the tag to form a tag transform;
b2) storing the tag dictionary offset in a dictionary index at an address pointed to by the tag transform.

3. The method of claim 1, wherein step (c) further includes the steps of:
c1) transforming the data entry to form a data transform;
c2) storing the data dictionary offset in a dictionary index at an address pointed to by the data transform.

4. The method of claim 2, wherein step (b1) further includes the steps of:
i) determining if the tag is unique;
ii) when the tag is unique, storing the tag in the dictionary store;
iii) when the tag is not unique, the tag is not stored in the dictionary store.

5. The method of claim 4, wherein step (i) further includes the steps of:
determining if a tag pointer is stored in the dictionary index at an address equal to the tag transform;
when the tag pointer is stored in the dictionary index, the tag is not unique.

6. The method of claim 5, further including the step of:
when the tag pointer is not stored in the associative index, the tag is unique.

7. The method of claim 1, wherein step (a) further including the step of:
a1) wherein each of the lines have a plurality of tags.

8. The method of claim 1 further including the steps of:
e) creating a map index;
f) determining if the tag is unique;
g) when the tag is unique, storing a pointer to a map location of the tag.

9. The method of claim 8, further including the steps of:
h) when the tag is not unique, determining if a duplicates flag is set;
i) when the duplicates flag is set, incrementing a duplicates count.

10. The method of claim 9, further including the steps of:
j) when the duplicates flag is not set, setting the duplicates flag;
k) setting the duplicates count to two.

11. The method of claim 10, further including the steps of:
l) calculating a transform of the tag with an instance count to form a first instance tag transform and a second instance tag transform;
m) storing a first map pointer in the map index at an address associated with the first instance tag transform.

12. The method of claim 11, further including the step of:
n) storing a second map pointer in the map index at an address associated with the second instance tag transform.

13. The method of claim 9, further including the steps of:
j) calculating a transform of the tag with an instance count equal to the duplicates count to form a next instance tag transform;
k) storing a next map pointer in the map index at an address associated with the next instance tag transform.

14. The method of claim 1 further including the steps of:
e) creating a map index;
f) determining if the data entry is unique;
g) when the data entry is unique, storing a pointer to a map location of the tag.

15. A system for storing a structured data document, comprising:
a map store having a plurality of cells each containing a dictionary pointer and a format character;
a dictionary store having a plurality of tags and a plurality of data entries; and
an associative index having a plurality of addresses each of the plurality of address having an entry flag.

16. The system of claim 15, further including a flattener that converts the structured data document into a flattened structured data document, the flattener connected to the map store.

17. The system of claim 16, further including a parser parsing the flattened structured data document for a tag and a data entry.

18. The system of claim 17, further including a transform generator connected to the parser, the transform generator converting the data entry into a tag transform.

19. The system of claim 15, further including a map index that contains a dictionary pointer.

20. The system of claim 15, wherein the format character is a delete number.

21. The system of claim 15, wherein some of the plurality of addresses are associated with a tag transform.

22. The system of claim 15, wherein some of the plurality of addresses are associated with a data transform.

23. The system of claim 15, further including a plurality of format characters.

24. The system of claim 23, wherein one of the plurality of format characters indicates a first new tag in a flattened line.

25. The system of claim 23, wherein one of the plurality of format characters indicates a number of consecutive tags closed after a data entry.

26. The system of claim 23, wherein one of the plurality of format characters indicates a parent line number of a flattened line.

27. The system of claim 23, wherein one of the plurality of format characters indicates an inserted a flattened line.

28. The system of claim 15, wherein the dictionary store includes a data dictionary store and a tag dictionary store.

29. A method of storing a flattened structured data document, comprising the steps of:
a) flattening the structured data document to form a flattened structured data document;
b) parsing each line of the flattened structured data document for a tag;
c) determining if the tag is unique;
d) when the tag is unique, storing the tag in a dictionary store.

30. The method of claim 29, further including the steps of:
e) storing a tag dictionary offset in a map store;
f) storing a plurality of format characters in the map store.

31. The method of claim 29, further including the steps of:
e) when the tag is not unique, determining a tag dictionary offset;
f) storing the tag dictionary offset in a map store.

32. The method of claim 29, wherein step (d) further includes the steps of:
d1) transforming the tag to form a tag transform;
d2) performing an associative lookup in a dictionary index using the tag transform.

33. The method of claim 32, further including the steps of:
d3) creating a map index that has a map pointer that points to a location in the map store of the tag, wherein the map pointer is stored at an address of the map index that is associated with the tag transform.
